(19) United States
(12) Patent Application Publication
(10) Pub. No.: US 2012/0050530 A1
(43) Pub. Date: Mar. 1, 2012

(54) USE CAMERA TO AUGMENT INPUT FOR PORTABLE ELECTRONIC DEVICE

(75) Inventors: Tiruvilwamalai Venkatraman Raman, San Jose, CA (US); Charles L. Chen, San Jose, CA (US); Chaitanya Gharpure, Mountain View, CA (US); Svetoslav Ganov, Santa Clara, CA (US)

(73) Assignee: GOOGLE INC., Mountain View, CA (US)

(21) Appl. No.: 12/872,091

(22) Filed: Aug. 31, 2010

(51) Int. Cl. H04N 7/18

(52) U.S. Cl. 348/142; 348/E07.085

(57) ABSTRACT

Systems and methods are provided for controlling a portable electronic device. The device includes a built-in image capturing device. The system detects, through the image capturing device, motions of user finger over the image capturing device. The system determines a pattern of the detected motions using timing information related to the detected motions, and controls the portable electronic device based on the determined pattern. The system also receives inputs from other input devices associated with the portable electronic device, and controls the device based on combination of the determined pattern and the received inputs.

### BACKGROUND OF THE INVENTION

Portable electronic devices such as mobile phones have different input interfaces that allow users to control the devices. These input interfaces may include touch screen, speaker, keypad, buttons and switches. Thus, a user may control various functions of the phone and user applications through touching motions and spoken words/phrases.

Portable devices often have various peripheral components as well, such as a camera, which is used to capture subjects and environments surrounding the device. Some portable devices have a built-in compass or an accelerometer that may be able to detect orientations or motions of the device.

### SUMMARY OF THE INVENTION

Aspects of invention provide systems and methods of controlling a mobile device by detecting and recognizing an object's motions based on images taken by an image capturing device and timing information related to the motions.

In one embodiment of the invention, a method for controlling a portable electronic device including an image capturing device is provided. The method comprises detecting, via the image capturing device, motions of an object over the image capturing device. The method also comprises determining a type of the detected motions using timing information related to the detected motions and controlling the portable electronic device based on the determined motion type. The timing information comprises duration of at least one of the detected motions.

In one example, the type of the detected motions comprises single tapping, double tapping, hovering, holding and swiping.

In another example, detecting motions comprises receiving images from the image capturing device. Each of the received images is associated with a motion of the object. Detecting motions also comprises determining an illumination level for each of the received images, comparing each of the determined illumination level to a predetermined threshold, and determining, for each received image, if the associated motion is a touch motion where the object touches on the image capturing device or a release motion where the object releases or stays away from the image capturing device based on the comparison.

In a further example, determining a type of the detected motions comprises determining time from a touch motion to a release motion.

In one alternative, determining a type of the detected motions comprises determining time from a release motion to a touch motion.

In another alternative, detecting motions comprises receiving images from the image capturing device, and detecting edges for each of the received images. Each of the received images is associated with a motion of the object.

In a further alternative, the method comprises comprising detecting, for images with edges, direction of a swiping motion.

In yet another alternative, the method comprises receiving inputs from input devices associated with the portable electronic device; and controlling the portable electronic device based on combination of the determined motion type and the received inputs.

In yet another example, controlling the portable electronic device comprises mapping the combination of the determined motion type and the received inputs to one of a plurality of predetermined combinations of input events. Each respective one of the plurality of predetermined combinations correlate with one or more control commands for controlling the device. Controlling the portable electronic device also comprises retrieving and executing the correlated one more control commands.

In another embodiment of the invention, a system of controlling a portable electronic device including an image capturing device is provided. The system comprises a processor coupled to the image capturing device and configured to process images received from the image capturing device; and a memory coupled to the processor. The memory stores instructions executable by the processor for detecting, via the image capturing device, motions of an object over the image capturing device, and instructions for determining a type of the detected motions using timing information related to the detected motions. The timing information comprises duration of one of the detected motions. The memory also stores instructions for controlling the portable electronic device based on the determined motion type.

In one example, the type of the detected motions comprises single tapping, double tapping, hovering, holding and swiping.

In another example, the instructions for detecting motions comprise instructions for receiving images from the image capturing device. Each of the received images is associated with a motion of the object. The instructions for detecting motions also comprise instructions for determining an illumination level for each of the received images, comparing each of the determined illumination level to a predetermined threshold, and determining, for each received image, if the associated motion is a touch motion where the object touches on the image capturing device or a release motion where the object releases or stays away from the image capturing device based on the comparison.

In a further example, the instructions for determining a type of the detected motions comprise instructions for determining time from a touch motion to a release motion.

In one alternative, instructions for determining a type of the detected motions comprise instructions for determining time from a release motion to a touch motion.

In another alternative, instructions for detecting motions further comprise instructions for receiving images from the image capturing device, where each of the received images is associated with a motion of the object; and detecting edges for each of the received images.

In a further alternative, the instructions further comprise instructions for detecting, for images with edges, direction of a swiping motion.

In yet another alternative, the system comprises instructions for receiving inputs from input devices associated with the portable electronic device, and instructions for controlling the portable electronic device based on combination of the determined motion type and the received inputs.

In yet another example, the instructions for controlling the portable electronic device further comprise instructions for mapping the combination of the determined motion type and the received inputs to one of a plurality of predetermined combinations of input events, where each respective one of the plurality of predetermined combinations correlate with one or more control commands for controlling the device; and instructions for retrieving and executing the correlated one more control commands.

### BRIEF DESCRIPTION OF THE DRAWINGS

FIG. 1 is an exemplary device in which aspects of the invention operate.

FIG. 2 is a functional diagram of a system in accordance with aspects of the invention.

FIGS. 3A-B are functional diagrams of systems in accordance with aspects of the invention.

FIGS. 4A-B are exemplary scenarios in accordance with aspects of the invention.

FIG. 5 is an exemplary scenario in accordance with aspects of the invention.

FIG. 6 is an exemplary scenario in accordance with aspects of the invention.

FIG. 7 is an exemplary scenario in accordance with aspects of the invention.

FIG. 8A-B are functional diagrams in accordance with aspects of the invention.

FIG. 9 is a flowchart in accordance with aspects of the invention.

FIG. 10 is a flowchart in accordance with aspects of the invention.

### DETAILED DESCRIPTION

In accordance with aspects of the invention, a system is provided for controlling a portable electronic device including an image capturing device such as a camera. The system detects, via the camera, motions relative to the camera. The motions include a touch on event or a release event from the camera. The system also determines a pattern of a series of detected motion events using timing information related to the events. The motion pattern includes tapping for a number of times such as single or double tapping, hovering, holding, and swiping. Each pattern correlates with a control function of the device. The system then performs the control function based on the mapping.

In accordance with further aspects of the invention, the system receives user instructions from other input devices associated with the portable electronic device, and controls the device based on a combination of the determined motion pattern and the received user instructions. The system may determine the control function to be performed by mapping the combination of the motion pattern and the received user instructions to one of a plurality of input gestures, where each of the input gestures corresponds to a control function of the device.

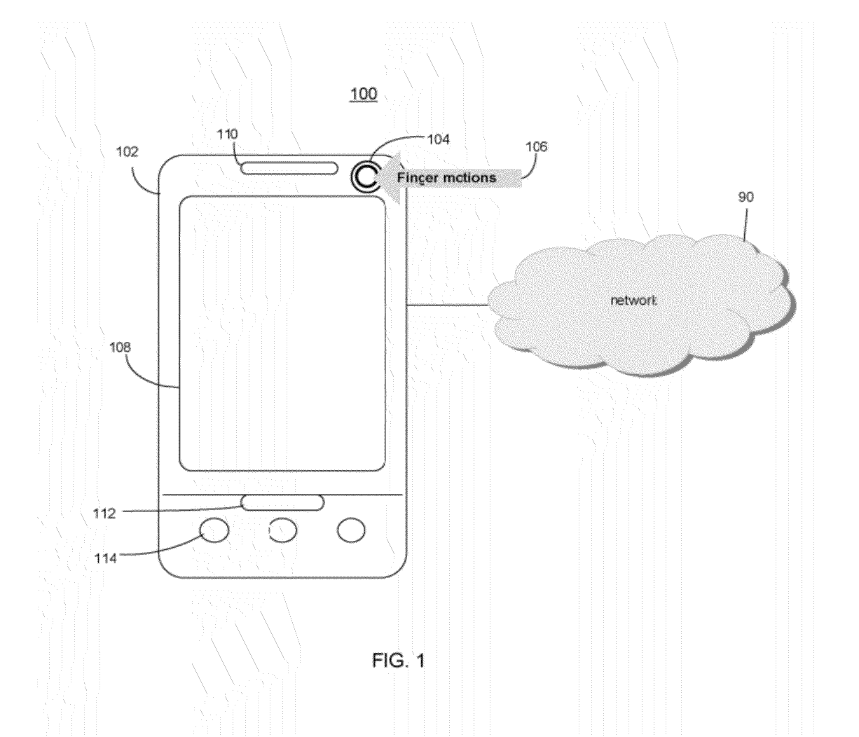

FIG. 1 shows one example of a system 100 in which a device 102 operates in accordance with aspects of the invention. The portable electronic device may be a mobile device (e.g., a smart phone such as Google Nexus) that is capable of communicating with other mobile devices through network 90. The portable electronic device may also be a music player, or any type of multi-function portable user device that has a built-in camera.

As illustrated, portable electronic device 102 includes an image capture device such as a camera 104. Camera 104 may be built into the phone and include one or more lens that are located on the front or back of the device such that the camera may capture any object before the lens. The object may be a user's finger moving in front of or over the camera lens. Camera 104 may also include various hardware electronic circuitries, optical components, as well as any embedded software to aid image capturing and processing functions.

The system and method may detect and recognize pattern of finger motions 106 within the field of view of the camera, and generate commands based on the pattern of the detected motions to control the user device accordingly. For example, the system and method may detect and determine a particular motion event over the camera (e.g., a touch on or a release from the camera) based on the illumination changes of the images captured by the camera. It may further derive, from a series of motion events, a pattern (e.g., a tap, double tap, a swipe or a hover on or across the camera) using timing information related to the motion events.

The motion pattern alone, or a combination of the motion pattern and input events from other input devices, may be mapped to one of the predetermined input gestures that are stored in the device. Each predetermined input gesture may correlate with one or more control commands for controlling various functions of the device. These functions may include call or voice message functions, music playing functions, web browsing functions, or document retrieval functions. For instance, a double tap on the camera while pressing on an address book entry displayed on a touch screen may be an input gesture to initiate a phone call to that particular contact. Accordingly, aspects of the invention may control the device based on the detected motion pattern alone, or a combination of the motion pattern and input events from other input devices.

User device 102 may comprise a variety of peripheral devices for receiving inputs from the user and presenting contents in various formats to the user. For example, the user device may comprise a small LCD display 108 (which may be a touch screen), a speaker 110, a microphone 112, and various types of buttons 114 to facilitate device control and navigation through the applications displayed on screen 108.

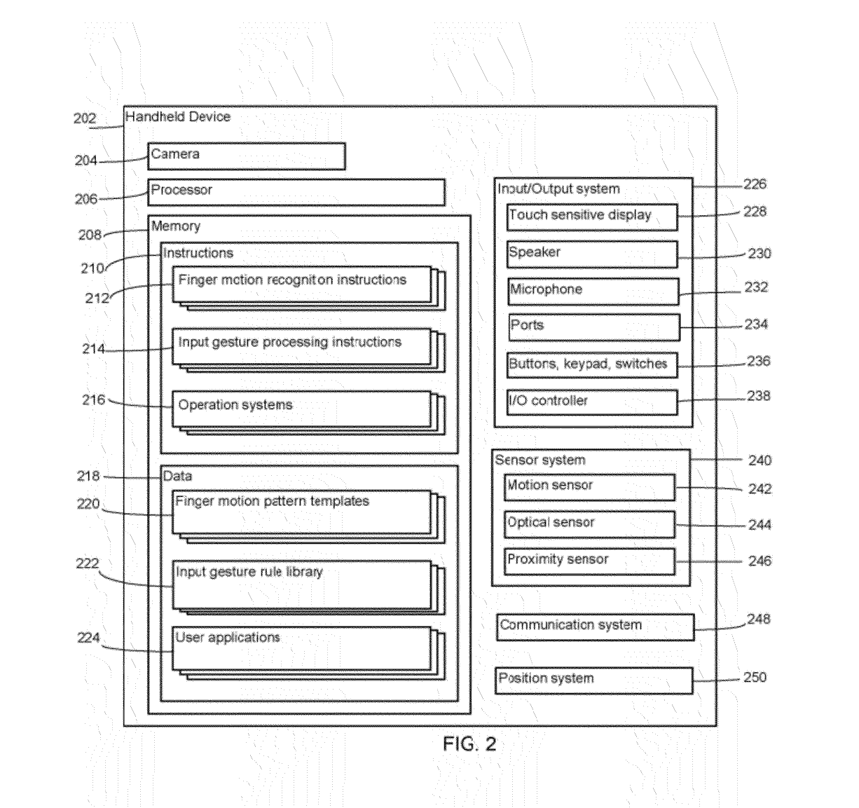

As shown in FIG. 2, the mobile device may include other components beyond camera 204, for example, one or more processors 206 such as a central processing unit (CPU), memory 208, input/output system 226 and various peripheral systems and components that are typically present in a portable electronic device or normally used in connection with such device. The processor 206 may be any conventional processor, such as off the shelf processors from Intel Corporation or Advanced Micro Devices. Alternatively, the processor may be a dedicated controller such as an ASIC.

Memory 208 stores information accessible by processor 206, including instructions 210 that may be executed or otherwise used by the processor 206. It also includes data 218 that may be retrieved, manipulated or stored by the processor. The memory may be of any type capable of storing information accessible by the processor, including a computer-readable medium, or other medium that stores data that may be read with the aid of an electronic device, such as an internal hard-drive, memory card, ROM, RAM, as well as other write-capable and read-only memories. Systems and methods may include different combinations of the foregoing, whereby different portions of the instructions and data are stored on different types of media.

Instructions 210 may include various sets of instructions to be executed directly (such as binary machine code) or indirectly (such as scripts from any programming language) by the processor. For example, the instructions may be stored as computer code on the computer-readable medium. In that regard, the terms “instructions” and “programs” may be used interchangeably herein. The instructions may be stored in object code format for direct processing by the processor, or in any other computer language including scripts or collections of independent source code modules that are interpreted on demand or compiled in advance.

Instructions 210 may comprise any instruction typically found in a mobile device, such as operating system instructions 216 (e.g., Android, Symbian, Windows), phone instructions for handling phone-related processes and functions such as text messaging, graphical user interface instructions, user application program instructions such as a web browser, location instructions for receiving and sending location data, peripheral device instructions to control various input, output, communication and sensor systems on the mobile device, etc.

Instructions 210 also include various programs or functions to facilitate detecting user finger motions over the camera, recognizing motion patterns, and translating the motion pattern into appropriate commands to control the mobile device and user applications. For example, instructions 210 may include finger motion recognition instructions 212 that detect the user's finger movements on or over the camera. The motion recognition instructions may also include various types of image processing functions, including functions for determining illumination level, functions for detecting edges, and functions for discerning one or more motion patterns from the images. Input gesture processing instructions 214 may map the motion pattern to input gestures and retrieve the control commands that correlate with the mapped input gesture. The input gesture processing instructions may also be configured to synchronize the finger motions detected by the camera and input events from other input devices. As such, input gestures may be defined by the combination of these input events.

Data 218 may be retrieved, stored or modified by processor 204 in accordance with the instructions 208. For instance, although the system and method is not limited by any particular data structure, the data may be stored in computer registers, in a relational database as a table having a plurality of different fields and records, XML documents or flat files. The data may also be formatted in any computer-readable format such as, but not limited to, binary values or Unicode. By further way of example only, image data may be stored as bitmaps comprised of grids of pixels that are stored in accordance with formats that are compressed or uncompressed, lossless (e.g., BMP) or lossy (e.g., JPEG), and bitmap or vector-based (e.g., SVG), as well as computer instructions for drawing graphics. The data may comprise any information sufficient to identify the relevant information, such as numbers, descriptive text, proprietary codes, references to data stored in other areas of the same memory or different memories (including other network locations) or information that is used by a function to calculate the relevant data.

Data 218 may store various types of data accessible by the instructions for system operations and application executions. For example, user applications 224 may include various widgets and application programs. For another example, data 218 may also include one or more pattern libraries 220 that store motion models or templates to facilitate motion recognition. A motion pattern (e.g., a double tap on the camera) may be defined by parameters such as motion events (e.g., touch or release) relative to the camera, duration time of the motion events, sequence and order of a series of motion events, angles or directions of the motions, or combinations of the foregoing and other gestures.

For example, a touch on the camera that lasts between 2 to 5 milliseconds and followed by a release from the camera may be considered a single tap. For another example, a touch on the camera followed by a release from the camera and another touch may represent a double tap. For a further example, a touch on the camera that lasts between 5 milliseconds and 10 milliseconds may represent a long stay (a tap-and-hold) on the camera. The pattern libraries may also include models for horizontal and vertical swiping across the camera with left/right or downward/upward directions.

Data 218 may also include one or more input gesture libraries 222 to facilitate generating control commands for the mobile device. The libraries may store predetermined motion patterns that are correlated to one or more sets of specific control commands. For example, the pattern of a long stay on the camera may correspond to a command to open the last browsed web page. Thus, systems and methods may match the detected motion pattern to the corresponding commands. Alternatively, control commands may be mapped to a combination of a finger motion pattern over the camera and simultaneous input events through other input interfaces (e.g., speech input through microphone, pressing on the primary touch screen, etc.).

In generating the control commands, the system may also take into account the operation mode of the device as well as the application(s) currently or previously active on the device. Therefore, the same motion pattern may correspond to different commands for different operation modes or application contexts. For example, a single tap on the camera may correlate to a command for opening the previous web page if the user device is in a web browsing mode, or for retrieving the last dialed phone number or for activating the primary touch screen if the user device is in an idle mode.

Predetermined sets of finger motion patterns and/or predetermined input gesture dictionaries may be stored in data 218 during the manufacturing process of the device. Alternatively, users of the device may be allowed to augment, change or build their own motion patterns and/or such input gesture dictionaries. For example, users may be allowed to associate a double tap on the camera while pressing the touch screen on a contact entry in the address book with a command to trigger a text message dialogue, or to associate the above input event combination with a command to initiate a phone call session.

The user device may include a variety of peripheral systems and components. These components are coupled to the processor and the memory through data bus lines and signal lines. Instructions to facilitate the operations of these components are stored in the memory. These peripheral components include camera 204. Each image captured by the camera may be stored as a set of pixels associated with color and brightness values. For example, if the images are stored in JPEG format, the image will be displayed as a set of pixels in rows and columns, with each pixel being associated with a value that defines the color and brightness of the image at the pixel's location.

The user device also includes input/output system 226 that comprises numerous components and necessary software controllers. For example, the I/O system may comprise one or more electronic displays 228 for visual output (e.g., a small LCD touch sensitive screen or any other electrical device that is operable to display information). The I/O system may also comprise one or more speakers 230 for audio output, microphone 232 for taking speech input and related digital speech processing modules. I/O system 226 may comprise input devices such as ports 234 (e.g., USB port or infrared port, etc.), control buttons 236 (e.g., keypad, buttons, thumb-wheels, switches, etc.) and various types of controllers 238.

These peripheral systems also include sensor system 240. Various types of sensors that are typically found on the user device may be included, such as motion sensor 242, optical sensor 244 (e.g., infrared sensors), proximity sensor 246, altimeter (not shown), etc.

The user device also comprises communication system 248 to facilitate the user device to communicate with one or more types of networks, such as cellular network, IEEE 802.x networks, Bluetooth Personal Area Network etc. The communication system may comprise network interface devices and associated controllers or drivers, e.g., transceiver and antenna, as well as all of the components used for connecting these elements to one another.

The user devices may also include position system 250. The position system may comprise one or more geographic position components to determine the geographic location and orientation of the device. For example, user device 202 may include a GPS receiver to determine the device's latitude, longitude and altitude position. The geographic position components may also comprise software for determining the position of the device based on other signals received at the user device, such as signals received at the antenna from one or more cellular towers or Wi-Fi signals received from Wi-Fi access points.

The position system may also include a compass, an accelerometer, gyroscope or other devices to determine the direction in which the device is oriented. In that regard, it will be understood that a client device's provision of location and orientation data as set forth herein may be provided automatically to the user, to one or more servers or other devices in communications with user device 202, or all the above.

These devices may be operated in accordance with instructions 210, and the instructions may process data received from these devices. By way of example, instructions 210 may contain algorithms to estimate the location of the device, or speech recognition algorithms to recognize input events from the microphones. Instructions 210 may also include various types of image processing functions to analyze the images taken by the camera, and lighting parameters obtained from the optical sensors.

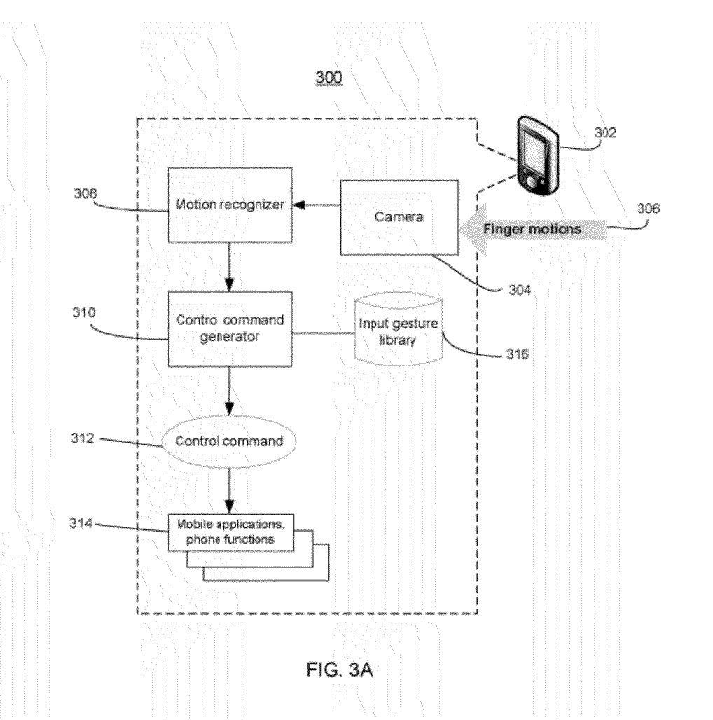

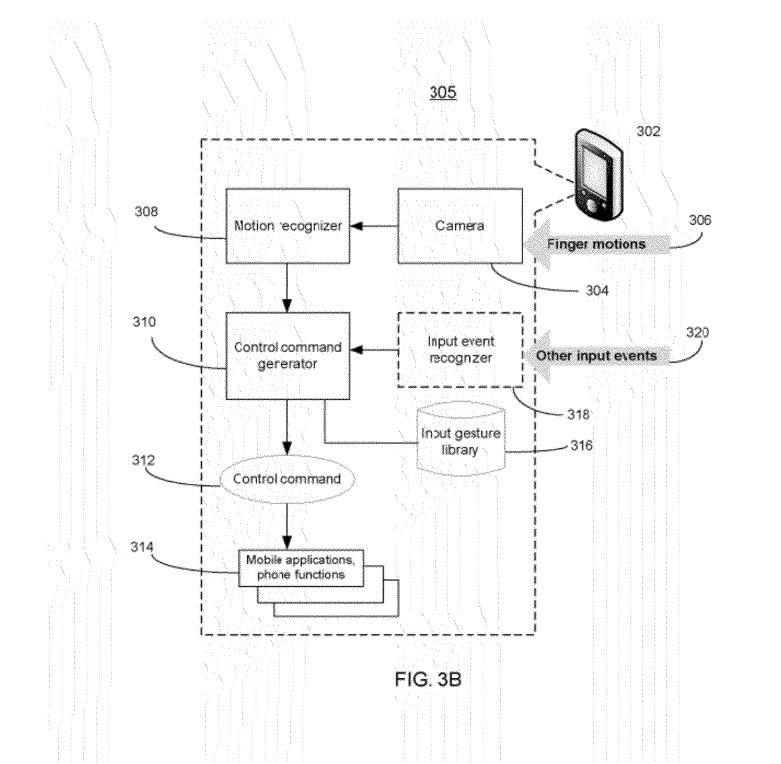

FIG. 3A illustrates certain of these functions performed by the components shown in FIG. 2. Here, user device 302 has a built-in camera 304. The system receives motion events 306 of a user's finger (or other objects of a user, e.g., a stylus pen) from the camera. A motion recognizer 308 recognizes the motion events and determines the type or pattern of these events. The recognized motion pattern is further mapped to a control command 312 by a control command generator 310 based on predetermined correlations between the motion patterns and control functions obtained from input gesture library 316. The command may be used to control user applications or device operation.

FIG. 3B illustrates another functional diagram in accordance with another aspect of the invention. User device 302 may be configured to detect multiple input events 306 and 320 from different input devices and translate the combination of the concurrent input events into a control command based on the rules in the input gesture library. For example, motion events 306 within the field of view of camera 304 may be detected and recognized by the motion recognizer. Another input event 316 (e.g., a touch on the primary touch sensitive display or a speech input through microphone) may be detected and recognized by an input event recognizer 318 that is associated with the respective input device (e.g., a touch recognition module or a speech recognition module). Aspects of the invention may also make use of input parameters automatically obtained by devices such as compass, accelerometer, etc. In this scenario, the control command generator 310 may map the combination of the above input events to a command 312, which may be used to initiate a particular control function of a user application or the device.

Although the user device shown in FIGS. 3A-B is a mobile phone, with the system may include other portable electronic devices that have built-in cameras.

Motion detector 308 may be implemented by various systems and methods to recognize finger motion events within proximity of the device. For example, the system may perform detecting and recognizing of the motion events based on illumination levels of images taken by the camera and timing information with regard to the motion events.

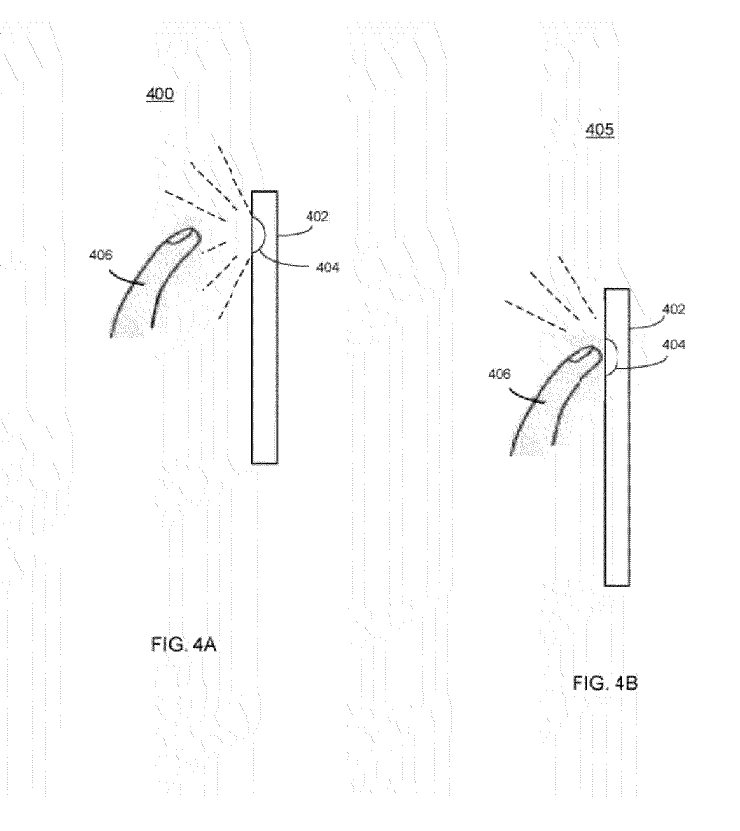

FIGS. 4A-B illustrate example scenarios 400 and 405 where motions over a camera on a user device are detected. In the scenario of FIG. 4A, user device 402 has a built-in camera 404 on the back side of the device. In this scenario, a user's finger 406 is away from the camera and the lens (not shown) of the camera is exposed to lights from the surrounding environment.

In the scenario of FIG. 4B, the user's finger makes a touch on the camera and the camera lens is less exposed to light than in scenario 400. Thus, the illumination level of an image taken in scenario 405 will be lower than the illumination level of an image taken in scenario 400. The average illumination of an image may be calculated by computing the illumination level of each of a number of pixels in an image. The number of pixels to be calculated may be determined by a selected resolution level for scanning the image.

Therefore, by calculating the illumination level of an image received from the camera and comparing the illumination level with a predetermined threshold value, the system may determine that a release or a touch event has occurred. If the illumination level falls under the threshold value, an event of touching the camera has occurred, such as the scenario of FIG. 4B. If the illumination level is on or above the threshold, an event of releasing from the camera has occurred (or a touch event has not occurred), such as the scenario of FIG. 4A. Although other image processing and recognizing methods may also be used to detect a touch event on a camera, determining the average illumination level of an image offers a simple solution and avoids cumbersome computation tasks. In one aspect, it is not necessary for the user's finger to directly touch the surface of the camera lens and it may be sufficient for the user's finger to be in a range close enough to the camera in order to have the average illumination level to fall below the threshold. In another aspect, the system may be configured to consider only direct touch scenarios.

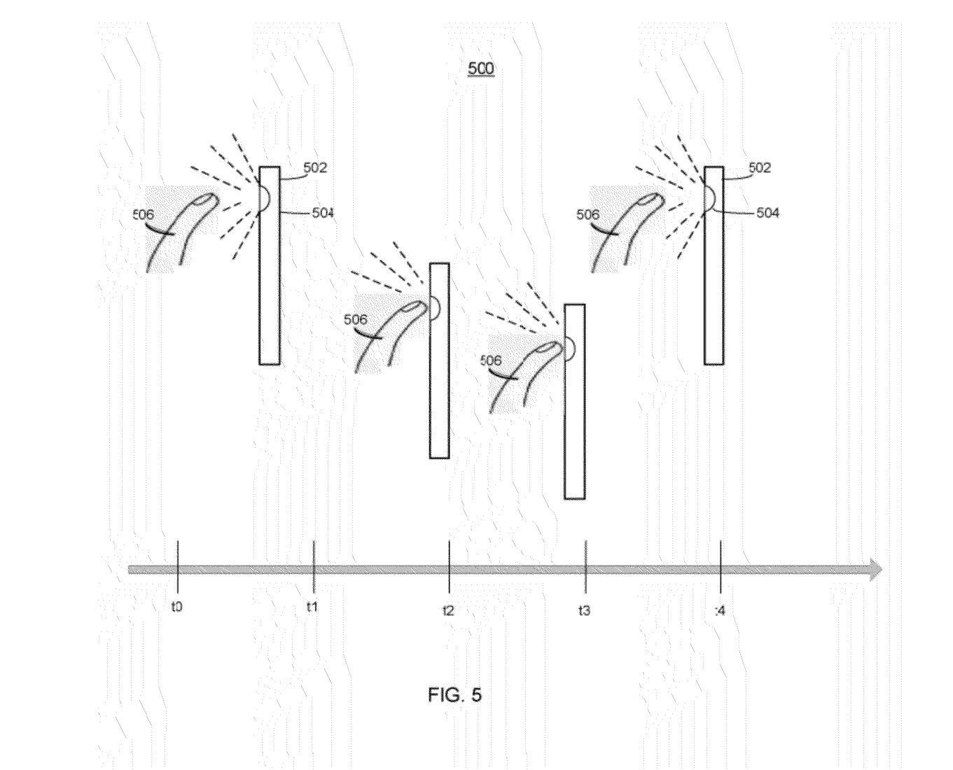

FIGS. 5-7 illustrate scenarios where systems and methods of the invention utilize timing information to recognize different motion patterns over the camera. FIG. 5 shows a scenario of a single tap on a built-in camera 504 on a user device 502. In scenario 500, a series of images may be taken from time t1 to t4. The system may apply the same scan resolution to each image received from the camera, so the number of pixels to be involved in computing the illumination level for each image stays the same.

As illustrated, at time t1, the user's finger 506 is still away from the camera. At time t2 and t3, the user's finger stays in touch with, or is in a close enough range from, the camera. Thus, the illumination levels of captured images at t2 and t3 are lower than the illumination levels of image at t1. If the illumination levels of images at t2 and t3 fall below a predetermined threshold, the system determines that a touch event has occurred at t2 and the event lasts through t3, i.e., the camera is touched by an object at time t2 and the touch stays through at least time t3.

At time t4, the user's finger has moved away from the camera. Thus, the illumination level of an image captured at t4 is higher than the illumination level at t2 and t3. If the illumination level of image at t4 is higher than the predetermined threshold, the system determines that a release event has occurred.

Based on the time taken for the illumination level changes from one to another (i.e., the duration of a touch or a release event), a pattern for a series of motions over the camera may be determined. For example, if the touch event lasts less than a threshold value (e.g., 5 milliseconds), the system may recognize the pattern as a single tap on the camera. A minimum duration time of a touch event may also be set by the system (e.g., 2 milliseconds) so that an accidental contact with the camera will not be recognized as a purposeful tap to control the device. Accordingly, a touch event that lasts between 2 to 5 milliseconds and followed by a release event may be recognized as a single tap for the purpose of generating corresponding control commands.

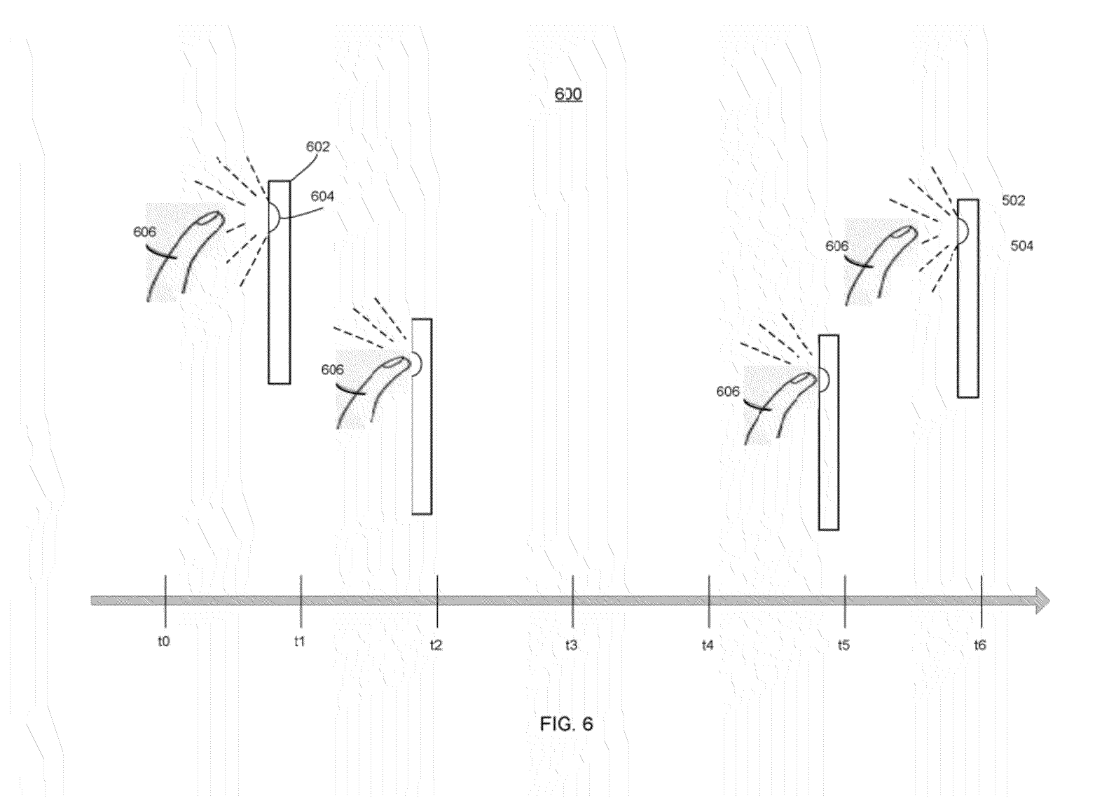

FIG. 6 illustrates a scenario of a long touch on a built-in camera 604 on a user device 602. In scenario 600, a series of images may be taken from time t1 to t6. At time t1, the average illumination level of an image received from the camera is above a minimum threshold value and the user's finger motion is determined to be a release event. At time t2, the user's finger has pressed onto the camera and the average illumination of an image taken at t2 falls below the minimum threshold. Accordingly, the system recognizes that a touch event has occurred.

One or more images may be taken between time t2 and time t6. For example, the illumination level of an image taken at time t5 is still below the threshold and another image taken at time t6 shows that the average illumination has exceeded the threshold. The system therefore determines the state of user's finger motion has switched from “touch” to “release”. Based on the time taken for the touch state to switch to the release state (the time span from t2 and t6), the system is able to determine whether the motions represent a single tap or a long touch. If the duration between t2 and t6 is above a predetermined maximum value set for a touch event (e.g., 5 milliseconds), the system may map the motion pattern to an input gesture of long touch.

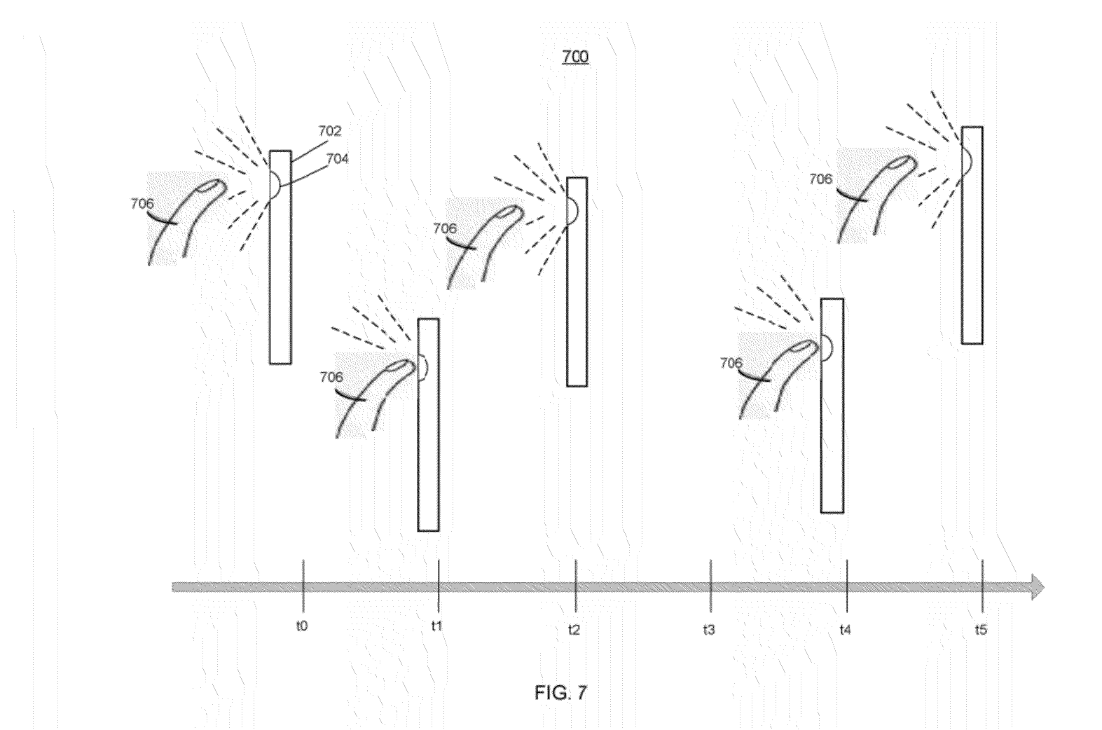

FIG. 7 illustrates a double tap scenario 700. Here, by collecting images during a time period from t0 to t5, calculating the illumination levels for the collected images and motion event durations, the system is able to determine the pattern of the series of motion events during the time period.

Specifically, based on the changes in average illumination levels, the system may determine that the finger motion has switched from a release state to a touch state at t1 and back to a release state at t2. The system may also determine that, at time t4, the finger motion state has switched again to a touch state and back to a release state at t5.

The system then calculates the time taken from release to touch (i.e., the time span from t0 to t1). The system may further calculate the time taken for the finger motion state to switch form touch to release (i.e., the time span from t1 to t2), and if such time is below a predetermined maximum value of a touch event (e.g., 5 milliseconds) the system may map the motion pattern before time t2 to a single tap.

Similarly, the motion pattern between time t2 and t5 may also be determined to be a single tap. The system may then map the pattern of two consecutive single taps followed by a release to a double tap pattern and generate the commands associated with the pattern.

Other types of user finger motions may be similarly determined from the average illumination level, timing information of motion events, and/or other related information obtained from the images. For example, in addition to determining the illumination level, the system may also use appropriate edge detecting methods to detect if any vertical or horizontal edges are present in the received images. If either a touch event or an edge is detected from an image, the system may record the position of the edge, collect data during a time frame and compare the readings to various image models of swiping motions. Based on the comparison, a pattern of the swiping motions may be derived (e.g., vertical downward, vertical upward, horizontal right and horizontal left, or swiping with in other angles and directions).

These different swiping patterns with varying angles or directions may correlate with different input gestures, and the system may generate commands accordingly. For example, a vertical swiping with a downward direction may be used to trigger a scroll down in a song list, while a vertical swiping with an upward direction may be used to trigger a scroll up in a song list.

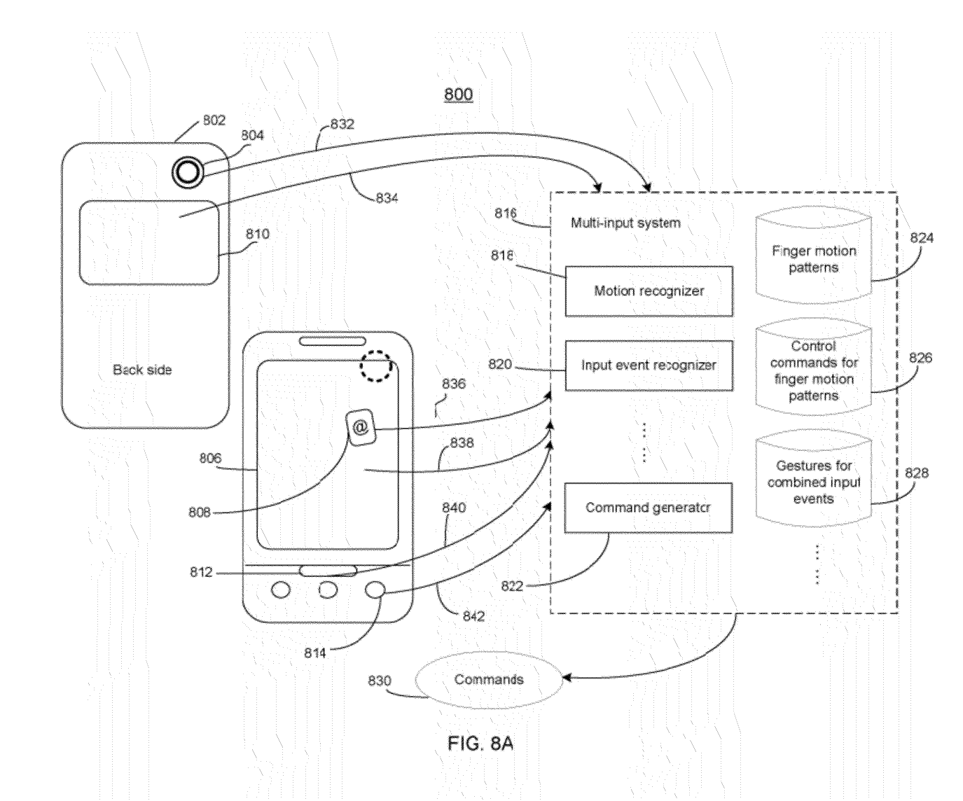

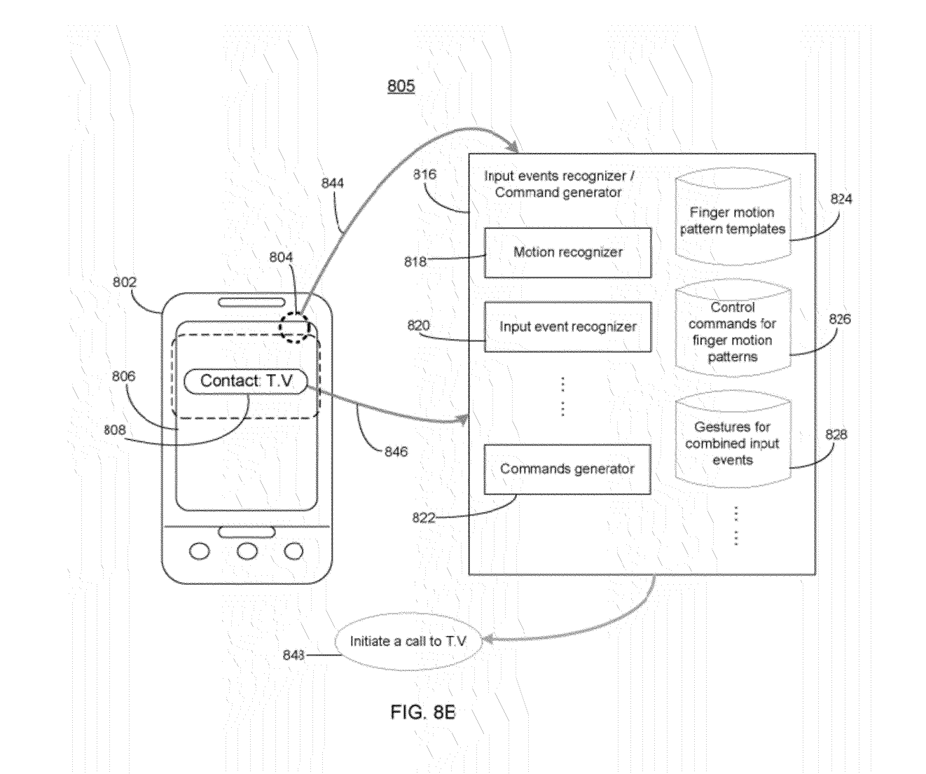

An input gesture may be defined by the motion pattern detected by the camera alone. Alternatively, the system may define an input gesture by a combination of the motion pattern from the camera with simultaneous or near-simultaneous input events detected by other input devices. FIG. 8A illustrates a functional diagram of a multi-input scenario. In scenario 800, a mobile device 802 has input devices such as a built-in camera 804, and a primary touch sensitive display 806 located on the front panel of the device. A user may be able to navigate various types of mobile applications displayed on the primary touch screen through finger motions. For example, the user may tap on an address book application 808 to open the address book and search for contact entries.

A secondary touch sensitive screen 810 may also be provided and located, for example, at the back side of the device. Other input devices are also available. These include, but not limited to, microphone 812 and switch button 814. Input events from these devices are received and processed by a multi-input system 816 implemented on the device. The multi-input system 816 comprise a variety of input event recognizers, motion pattern libraries, and other necessary programs and data for recognizing the input gestures and translating the gestures into control commands.

For example, the finger motion events 832 detected by the camera may be processed by a motion recognizer 818 and with reference to a finger motion pattern library 824. Motion recognizer 818 may include all necessary image processing functions discussed above. The motion pattern library may store imaging models of swiping and tapping patterns. Control commands may be generated by mapping the recognized motion pattern to the correlated commands in a rule library 826.

Other input events, for example, a tap 836 on the address book application, a stroke 838 through the primary touch screen, a speech input 840 through the microphone and a press 842 over the button, may be recognized by an input event recognizer 820. The input event recognizer may comprise corresponding hardware circuitries and algorithms for recognizing the inputs and controlling the device. For instance, the multi-input system may include a speech recognizer with necessary speech models and patterns.

The inputs from different sources may be synchronized by the multi-input system and mapped to specific input gestures. For example, in gesture library 828, a speech input of a person's name with a simultaneous single tap on the camera may correlate with a gesture to initiate a text message dialogue to that person, and the combination of the same speech input with a simultaneous long stay on the camera may correlate with a call to that person. Upon receiving the input events, command generator 822 may refer to the gesture library and generate the corresponding control commands 830 to trigger the appropriate applications or phone functions. In this way, a complex gesture system may be built taking into account multiple inputs and various combinations of the inputs.

FIG. 8B illustrates an example multi-input scenario. Here, the combination of a double tap 844 on the camera with a simultaneous long press 846 on contact entry “T.V” may correlate to a gesture of making a phone call to “T.V”. Accordingly, the multi-input system generates a call initiating command 848.

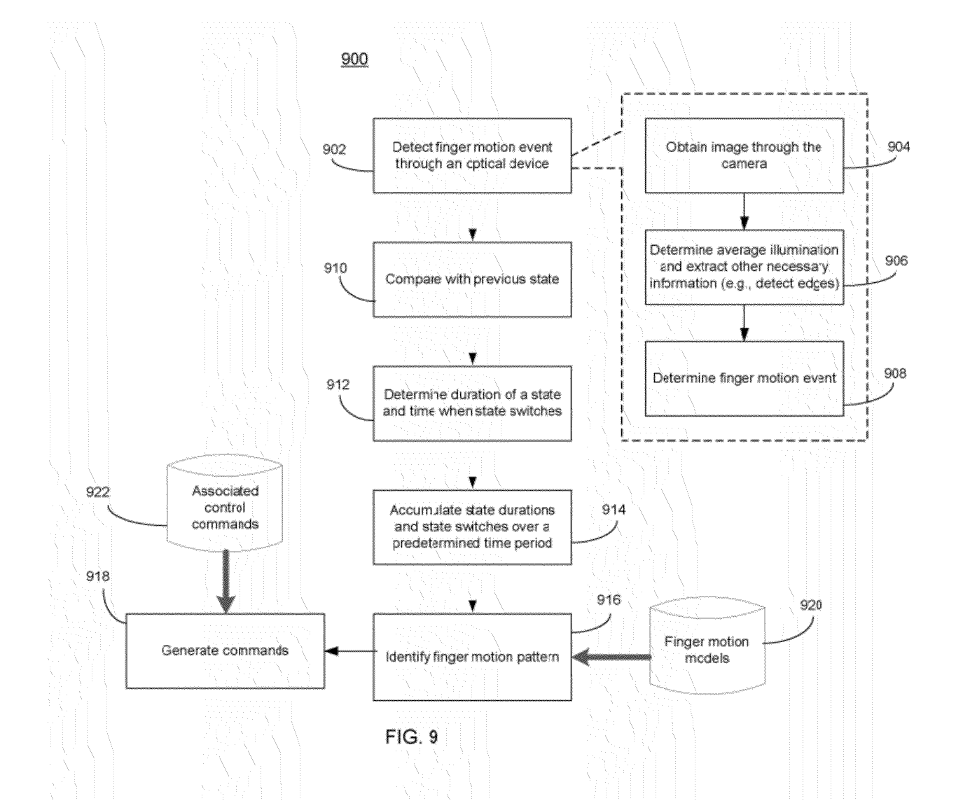

FIG. 9 shows an example flowchart in accordance with aspects of the invention. Process 900 may start in block 902, where the system detects user finger motion through an optical device, which may be a camera or other appropriate image capture devices that an average illumination level may be determined. The system may perform the process in this block as following.

In block 904, the system obtains an image through the camera on the device and calculates the average illumination level for the obtained image in block 906. The system may also perform other image processing functions to extract needed information from the image (e.g., detecting edges). In block 908, the system determines the motion event associated with the image based on the illumination level and/or other extracted information.

Returning back to the main process, in blocks 910 and 912, the system compares the current event state (e.g., a touch state) to the previous event state (e.g., a release state) and determines the time taken for a state to switch from one to another if the current state is different than the previous state. If the current state is the same as the previous state, the system may determine the duration of the state (e.g., duration of a touch event). In block 914, the system may have accumulated the detected event state and timing information. Thus, identification of the pattern for a series of motion events may be performed in block 916 by referring to the motion models in library 920. In block 918, the system may generate the control commands by mapping the determined pattern to the corresponding control commands in a control function library 922.

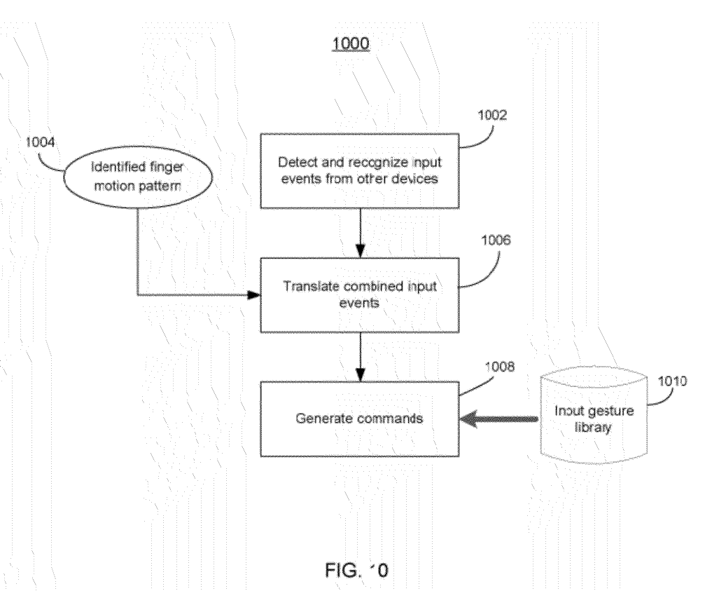

FIG. 10 shows a flow chart for a multi-input scenario. In block 1002, the system receives and recognizes input events from other input devices. In block 1006, the system synchronizes the identified pattern 1004 for finger motions over the camera with the recognized input events from other sources. In block 1008, the system performs translation of the combined input events based on input gesture rules 1010.

Systems and methods are not limited to any particular type of portable electronic device, but may be used with any device that has at least one input device and is capable of obtaining images for calculating illumination levels in accordance with aspects of the invention.

Aspects, features and advantages of the systems and methods will be appreciated when considered with reference to the above description of exemplary embodiments and accompanying figures. The same reference numbers in different drawings may identify the same or similar elements. Furthermore, the above description is not limiting; the scope of the invention is defined by the appended claims and equivalents.

It will be further understood that the sample values, types and configurations of data described and shown in the figures are for the purposes of illustration only. In that regard, systems and methods in accordance with aspects of the invention may include various types of user device, imaging acquiring device, touch sensitive surfaces, data values, data types and configurations, and different methods and systems for collecting images and processing the image data. The systems and methods may be provided and received at different times (e.g., the input gesture library may be embedded during the device manufacturing process and/or be downloaded over networks from associated servers or databases) and by different entities (e.g., some values may be pre-suggested or provided from different sources). In situations where the portable device is a mobile device in connection with one or more networks, operations described as being performed on the device and data being processed on the device may be performed and processed on servers, other devices or various types of network entities in connection with the device, and vice versa.

As these and other variations and combinations of the features discussed above can be utilized without departing from the invention as defined by the claims, the foregoing description of exemplary embodiments should be taken by way of illustration rather than by way of limitation of the invention as defined by the claims. It will also be understood that the provision of examples of the invention (as well as clauses phrased as “such as,” “e.g.”, “including” and the like) should not be interpreted as limiting the invention to the specific examples; rather, the examples are intended to illustrate only some of many possible aspects.

Unless expressly stated to the contrary, every feature in a given embodiment, alternative or example may be used in any other embodiment, alternative or example herein. For instance, any image processing method and/or methods making use of timing information of motion events may be used. Various ways of determining motion pattern may be used in any configuration herein. Similarly, various ways of synchronizing multiple input events may be adopted. Any predetermined motion models or patterns may be used with any of the configurations herein.

1. A method of controlling a portable electronic device including an image capturing device, the method comprising:
detecting, via the image capturing device, motions of an object over the image capturing device;
determining a type of the detected motions using timing information related to the detected motions, the timing information comprising duration of at least one of the detected motions; and
controlling the portable electronic device based on the determined motion type.

2. The method of claim 1, wherein the type of the detected motions comprises single tapping, double tapping, hovering, holding and swiping.

3. The method of claim 1, wherein detecting motions comprises:
receiving images from the image capturing device, each of the received images is associated with a motion of the object;
determining an illumination level for each of the received images;
comparing each of the determined illumination level to a predetermined threshold; and
determining, for each received image, if the associated motion is a touch motion where the object touches on the image capturing device or a release motion where the object releases or stays away from the image capturing device based on the comparison.

4. The method of claim 3, wherein determining a type of the detected motions comprises determining time from a touch motion to a release motion.

5. The method of claim 3, wherein determining a type of the detected motions comprises determining time from a release motion to a touch motion.

6. The method of claim 1, wherein detecting motions comprises:
receiving images from the image capturing device, each of the received images is associated with a motion of the object; and
detecting edges for each of the received images.

7. The method of claim 6 further comprising detecting, for images with edges, direction of a swiping motion.

8. The method of claim 1 further comprising:
receiving inputs from input devices associated with the portable electronic device; and
controlling the portable electronic device based on combination of the determined motion type and the received inputs.

9. The method of claim 8, wherein controlling the portable electronic device comprises:
mapping the combination of the determined motion type and the received inputs to one of a plurality of predetermined combinations of input events, wherein each respective one of the plurality of predetermined combinations correlate with one or more control commands for controlling the device; and
retrieving and executing the correlated one more control commands.

10. A system of controlling a portable electronic device including an image capturing device, the system comprising:
a processor coupled to the image capturing device and configured to process images received from the image capturing device;
a memory coupled to the processor, the memory storing instructions executable by the processor for:
detecting, via the image capturing device, motions of an object over the image capturing device;
determining a type of the detected motions using timing information related to the detected motions, the timing information comprising duration of one of the detected motions; and
controlling the portable electronic device based on the determined motion type.

11. The system of claim 10, wherein the type of the detected motions comprises single tapping, double tapping, hovering, holding and swiping.

12. The system of claim 10, wherein instructions for detecting motions further comprising instructions for:
receiving images from the image capturing device, each of the received images is associated with a motion of the object;
determining an illumination level for each of the received images;
comparing each of the determined illumination level to a predetermined threshold; and
determining, for each received image, if the associated motion is a touch motion where the object touches on the image capturing device or a release motion where the object releases or stays away from the image capturing device based on the comparison.

13. The system of claim 12, wherein instructions for determining a type of the detected motions further comprising instructions for determining time from a touch motion to a release motion.

14. The system of claim 12, wherein instructions for determining a type of the detected motions further comprising instructions for determining time from a release motion to a touch motion.

15. The system of claim 10, wherein instructions for detecting motions further comprising instructions for:
receiving images from the image capturing device, each of the received images is associated with a motion of the object; and
detecting edges for each of the received images.

16. The system of claim 15, wherein the instructions further comprising instructions for detecting, for images with edges, direction of a swiping motion.

17. The system of claim 10, further comprising instructions for:
receiving inputs from input devices associated with the portable electronic device; and
controlling the portable electronic device based on combination of the determined motion type and the received inputs.

18. The method of claim 17, wherein the instructions for controlling the portable electronic device further comprising instructions for:
mapping the combination of the determined motion type and the received inputs to one of a plurality of predetermined combinations of input events, wherein each respective one of the plurality of predetermined combinations correlate with one or more control commands for controlling the device; and
retrieving and executing the correlated one more control commands.
